(19) United States
(12) Patent Application Publication
(10) Pub. No.: US 2024/0420201 A1
(43) Pub. Date: Dec. 19, 2024

(54) INFORMATION DISPLAYING METHOD, APPARATUS, ELECTRONIC DEVICE AND STORAGE MEDIUM

(71) Applicant: Beijing Youzhuju Network Technology Co., Ltd., Beijing (CN)

(72) Inventors: Li Wang, Beijing (CN); Zhiyao Xie, Beijing (CN); Qiang Fu, Beijing (CN)

(21) Appl. No.: 18/744,423

(22) Filed: Jun. 14, 2024

(30) Foreign Application Priority Data
Jun. 15, 2023 (CN) 202310716381.2

(51) Int. Cl. G06Q 30/0601; H04N 21/2187

(52) U.S. Cl. CPC G06Q 30/0621; G06Q 30/0643; H04N 21/2187

(57) ABSTRACT

The present application relates to an information displaying method, apparatus, electronic device and storage medium. The method comprises: displaying an information feed page, the information feed page comprising an object display page; the information feed page corresponding to several objects to be displayed; the object display page being used for displaying summary information of at least one of the objects to be displayed and an ordering option; the summary information of the at least one object to be displayed comprising specification attribute information of the object to be displayed; and in the event that the at least one specification attribute information of the object to be displayed is in a selected state, in response to a triggering operation of the ordering option corresponding to a selected object to be displayed, displaying an order confirmation page corresponding to the selected object to be displayed.

### CROSS-REFERENCE TO RELATED APPLICATION(S)

This application claims priority to Chinese Application No. 202310716381.2 filed on Jun. 15, 2023, the disclosure of which is incorporated herein by reference in its entity.

### FIELD

The present application relates to the field of information display, and in particular, to an information displaying method, apparatus, electronic device and a storage medium.

### BACKGROUND

With the continuous development of live video streaming technology, people's needs for functions related to the live streaming channel get increasingly diversified, especially the live page display mode, display content, ordering process and the like that are closely related to the live watching experience of people.

Therefore, how to meet the diversified live page display needs of users to enhance the live watching experience of users is an urgent problem to be solved at present.

### SUMMARY

To solve or at least partly solve the above technical problems, the embodiments of the present disclosure provide an information displaying method, apparatus, electronic device and a storage medium.

In a first aspect, the present disclosure provides an information displaying method, comprising:
displaying an information feed page, the information feed page comprising an object display page; the information feed page corresponding to several objects to be displayed; the object display page being used for displaying summary information of at least one of the objects to be displayed and an order option; and the summary information of the at least one object to be displayed comprising specification attribute information of the object to be displayed; and
in the event that the at least one specification attribute information of the object to be displayed is in a selected state, in response to a triggering operation of the order option corresponding to a selected object to be displayed, displaying an order confirmation page corresponding to the selected object to be displayed, the selected object to be displayed being an object to be displayed with the at least one specification attribute information in the selected state.

In a second aspect, the present disclosure further provides an information displaying apparatus, comprising:
a first displaying module configured to display an information feed page, the information feed page comprising an object display page; the information feed page corresponding to several objects to be displayed; the object display page being used for displaying summary information of at least one of the objects to be displayed and an order option; and the summary information of the at least one object to be displayed comprising specification attribute information of the object to be displayed; and
a second displaying module configured to: in the event that the at least one specification attribute information of the object to be displayed is in a selected state, in response to a triggering operation of the order option corresponding to a selected object to be displayed, display an order confirmation page corresponding to the selected object to be displayed, the selected object to be displayed being an object to be displayed with the at least one specification attribute information in the selected state.

In a third aspect, the present disclosure further provides an electronic device, comprising:
one or more processors;
a storage unit for storing one or more programs;
wherein the one or more programs, when executed by the one or more processors, cause the one or more processors to implement the information displaying method as described above.

In a fourth aspect, the present disclosure further provides a computer readable storage medium storing a computer program thereon, wherein the computer program, when executed by a processor, implements the information displaying method as described above.

Compared with the prior art, the technical solution provided by the embodiments of the present disclosure boast the following advantages:

In the technical solution provided by the embodiments of the present disclosure, an information feed page is displayed, the information feed page comprising an object display page; the information feed page corresponds to several objects to be displayed; the object display page is used for displaying summary information of at least one of the objects to be displayed and an ordering option; the summary information of the at least one object to be displayed comprises specification attribute information of the object to be displayed; and in the event that the at least one specification attribute information of the object to be displayed is in a selected state, in response to a triggering operation of the order option corresponding to a selected object to be displayed, an order confirmation page corresponding to the selected object to be displayed is displayed, the selected object to be displayed being an object to be displayed with the at least one specification attribute information in the selected state. In general, the specification attribute information of the object to be displayed is transparently transmitted to the object display page. As such, the user can directly select the specification attribute information of the object to be displayed on the object display page, which can simplify the steps of placing an order to buy the object to be displayed and shorten the time consumption of the operations of placing an order.

### BRIEF DESCRIPTION OF THE DRAWINGS

The accompanying drawings herein are incorporated into the specification and constitute part of the specification, depict the embodiments of the present disclosure and are used to explain the principles of the present disclosure together with the specification.

To illustrate the embodiments of the present disclosure or the technical solutions in the prior art more clearly, a brief introduction is presented below to the drawings to be used in the embodiments or the description of the prior art. It is obvious that for those of ordinary skill in the art, they may further derive other drawings from these accompanying drawings without the exercise of any inventive skill.

FIG. 1 shows a flowchart of an information displaying method provided by the embodiments of the present disclosure;

FIGS. 2 to 4 show schematic diagrams of several information feed pages provided by the embodiments of the present disclosure;

FIG. 5 shows a structural schematic diagram of an information displaying apparatus in the embodiments of the present disclosure; and

FIG. 6 shows a structural schematic diagram of an electronic device in the embodiments of the present application.

### DETAILED DESCRIPTION OF EMBODIMENTS

For a clearer understanding of the above objectives, features and advantages of the present disclosure, the solution of the present disclosure will be further described below. It is to be noted that the embodiments and features in the embodiments of the present disclosure may be combined with each other without conflict.

Many specific details are set forth in the following description in order to facilitate a full understanding of the present disclosure, but the present disclosure can further be implemented in other ways different from those described herein. Apparently, the embodiments in the specification are merely part of rather than all of the embodiments of the present disclosure.

In live streaming scenarios, the item list in the live streaming room (or channel) often includes item cards of a plurality of items. For example, the item list includes an item card of item A, and item A has many colors, such as red, white and blue. If the user wants to place an order for item A in red, they need to click on the item card of item A in the item list to enter the item details page of item A, and then click on the “Buy Now” option to enter the specifications and attributes selection page of item A, where all color options of item A are displayed. The user selects red in the specifications and attributes selection page of item A and clicks on the “OK” option to enter the order confirmation page. The user clicks on the “Submit Order” on the order confirmation page to complete the entire ordering process. The entire operation of placing an order is cumbersome and it takes a long time, and thus the user experience is poor.

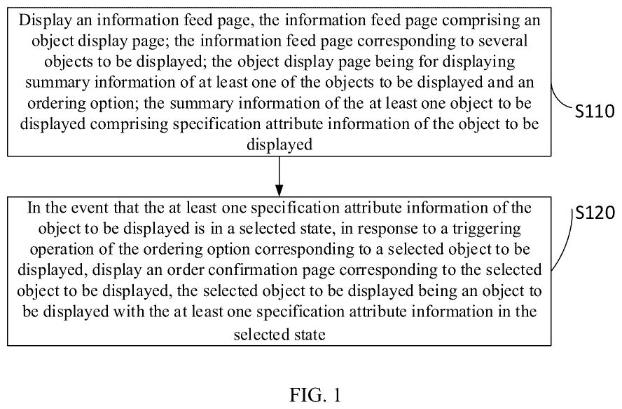

FIG. 1 shows a flowchart of an information displaying method provided by an embodiment of the present disclosure. This embodiment may be applicable to displaying information on a client. The method may be performed by an information displaying apparatus. The apparatus may be implemented in software and/or hardware and may be configured in an electronic device such as a terminal, including without limitation to, a smart phone, a PDA, a tablet, a wearable device with a display screen, a desktop computer, a notebook computer, an all-in-one computer, a smart home device, and the like.

As shown in FIG. 1, the method may specifically comprise:

S110, displaying an information feed page, wherein the information feed page comprises an object display page; the information feed page corresponds to several objects to be displayed; the object display page is used for displaying summary information of at least one of the objects to be displayed and an order option; and the summary information of the at least one object to be displayed comprises specification attribute information of the object to be displayed.

The information feed page may be, for example, a page in the application client for displaying an information feed in an information feed playing sequence.

The information feed playing sequence is a data form that provides content to the user on a continuous basis. The information feed playing sequence comprises a set of information/content. The set of information/content comprises a plurality of pieces of information/content, which are sequentially arranged in a certain order to form the information feed playing sequence.

The information feed refers to each piece of information and/or content in the information feed playing sequence. The information feed playing sequence is a collection formed by a plurality of information feeds. As an example, if the information feed playing sequence is a set of videos, then each video is an information feed.

In some embodiments, the types of different information feeds in the same information feed playing sequence can be the same or different. The types of information feeds may include, but are not limited to, live preview videos, live videos, short videos, and graphical information. The live preview video may be, for example, a video for attracting views to the live streaming room. The live video may be, for example, a video reflecting the content that is being broadcast in the live streaming room. The short video may be a video clip for example. The graphic information may for example recommend some content to the user, such as recommending an application or recommending a page mini-game, etc.

Optionally, the information feed page comprises a live streaming room preview feed page or a live streaming room display page; the live streaming room preview feed page may be, for example, a page for playing the live preview video before entering the live streaming room. The live streaming room display page may be a page for playing the live video after entering the live streaming room.

The object to be displayed may be, for example, something that wants to be displayed to the user. In some embodiments, under e-commerce scenarios, the object to be displayed may be an item for example. Specifically, the object to be displayed may include purchasable items or services, etc. The object to be displayed comprises a plurality of attributes. The attribute of the object to be displayed may be, for example, a feature of the object due to its own construction, composition, etc. If the object to be displayed is an item, the attributes of the object to be displayed include the name, brand, category, style, size, material, function, logo, type, price, color and packaging of the object, etc. If the object to be displayed is a service, its attributes are the content included in the object to be displayed, such as brand, category, notes, price, etc.

“The information feed page corresponding to several objects to be displayed” may be: for example, what is displayed to the user through an information feed page is an object to be displayed corresponding to the information feed page. Under e-commerce scenarios, if the information feed page is a live streaming room preview feed page or a live streaming room display page, the object to be displayed corresponding to the information feed page is an item sold in the live streaming room.

The object display page may be, for example, a page for summarizing-displaying summary information of an object to be displayed corresponding to an information feed page. Optionally, the object display page may be an object display list. In the object display page, the summary information of each object to be displayed may be displayed in the form of a card. One card displays the summary information of one object to be displayed. Under e-commerce scenarios, the object display page may be an item list.

The summary information of the object to be displayed may be, for example, a collection formed by part of attribute information of the object to be displayed. The summary information of the object to be displayed is used for briefly displaying an overview of the object to be displayed in the form of text and/or images to the user. Under e-commerce scenarios, the summary information of the object to be displayed may be construed as an item card in the item list. In practice, there may further exist an object details page of the object to be displayed, which is used for displaying in detail all attribute information of the object to be displayed. In general, one object details page is only for displaying all attribute information of one object to be displayed. With respect to the same objects to be displayed, the information amount displayed in the object details page is greater than the information amount of attribute information displayed in the summary information. Under e-commerce scenarios, the object details page of the object to be displayed is an item details page.

The specification attribute information is one or more of attributes of the object to be displayed. By selecting the specification and attribute information, the stock keeping unit (SKU) can be defined. The stock keeping unit, the basic unit for the measurement of stock in and out, is the minimum unit that defines an item and is determined by an attribute combination of the item. For example, a garment has several specification attributes that can be selected by the user, such as size and color. Assuming that there are 3 choices of size and color for a given garment, then this garment has 9 (3×3=9) stock keeping units. Each stock keeping unit has a unique code, which serves to distinguish and record information on different attribute combinations. In other words, an object to be displayed may comprise one or more specification attribute information, and a stock keeping unit may be obtained through one or more combinations of specification attribute information. As an example, the specification attribute information comprises at least one of: a size, a style, a material and a color.

In practice, the object to be displayed might have a plurality of specification attribute information. The specification attribute information may be specification attribute information of the same category or different categories. The category of the specification attribute may be a size, a style, a material, and a color, etc.

As an example, if a plurality of specification attribute information of an object to be displayed is all specification attribute information of the size category, the plurality of specification attribute information of the object to be display may specifically be small, large, medium, etc. If a plurality of specification attribute information of an object to be displayed may be divided into two categories, color and size, then the plurality of specification attribute information of the object to be displayed may specifically include small, large, medium, white, yellow, pink, etc.

The ordering option is an option specially designed for an object to be displayed with summary information including specification attribute information and used to quickly buy the object to be displayed. After the ordering option is triggered, the order confirmation page will be directly displayed, while the specification attribute selection page will not be displayed, nor will the item details page be displayed.

S120, in the event that the at least one specification attribute information of the object to be displayed is in a selected state, in response to a triggering operation of the order option corresponding to a selected object to be displayed, displaying an order confirmation page corresponding to the selected object to be displayed, where the selected object to be displayed is an object to be displayed with the at least one specification attribute information in the selected state.

The selected object to be displayed refers to an object to be displayed with the at least one specification attribute information in the selected state.

The triggering operation of the ordering option may be, for example, a clicking or swiping operation of the ordering option. The triggering operation of the ordering option corresponding to the object to be displayed may indicate that the user wishes to buy the item corresponding to the stock keeping unit which is defined by the specification attribute information in the selected state.

The order confirmation page refers to a page that summarize-display to the user all specification attribute information in the selected state of the target object to be displayed, and is a page where the user confirms information for the last time before placing the order. After displaying the order confirmation page, the terminal will enter the section of guiding the user to pay for the order.

In some scenarios, all of the several objects to be displayed corresponding to the information feed page might be target objects to be displayed; or all of the several objects to be displayed corresponding to the information feed page might be non-target objects to be displayed; or part of the several objects to be displayed corresponding to the information feed page might be target objects to be displayed, and the other part thereof might be non-target objects to be displayed.

The target object to be displayed is an object to be displayed which is filtered from all objects to be displayed corresponding to the information feed page and which meets a preset filtering condition. Optionally, the target object to be displayed comprises at least one of: an object to be displayed an object to be displayed in an explained state, an object to be displayed with a display priority satisfying a preset display condition, and an object to be displayed with a heat value satisfying a preset heat condition.

The state of the object to be displayed comprises an explained state and a to-be-explained state. In scenarios of live streaming, the streamer may explain respective objects to be displayed corresponding to the information feed page (i.e., respective objects to be displayed corresponding to the live streaming room) one after another. The object to be displayed which is currently explained by the streamer is in the explained state. Except for the object to be displayed in the explained state, the rest of the objects to be displayed are in the to-be-explained state.

The display priority of an object to be displayed is a basis used for judging whether the object to be displayed can be used as the target object to be displayed. The display priority information of the object to be displayed may be specified in advance, or determined based on one or more specific attribute information (e.g., type, price, stocks, etc.), or determined based on interests and needs of the group to which the user watching the live streaming belongs, which is not limited in the present application. As an example, the object to be displayed with a preset “featured” label has a higher display priority than other objects to be displayed. The preset display condition is a judgment condition for judging whether an object to be displayed may be used as the target object to be displayed. The present application is not intended to limit the specific content of the preset display condition. As an example, the preset display condition may be the highest display priority.

The heat value of an object to be displayed is information that characterizes the popularity degree of the object to be displayed in numerical form. As an example, the heat information of the object to be displayed comprises at least one of: the number of followers, favorites, purchases, reviews, positive reviews, shares, views, inquiries, and likes of the object to be displayed. The present application is not intended to limit the specific content of the preset heat condition. As an example, the preset heat condition may be the most positive reviews.

The non-target object to be displayed is an object to be displayed corresponding to the information feed page and not satisfying the preset filtering condition. In other words, among all the objects to be displayed corresponding to the information feed page, except for the target object to be displayed, the rest of the objects to be displayed are non-target objects to be displayed.

As an example, if the target object to be displayed is an object to be displayed in the explained state, then the non-target object to be displayed is an object to be displayed in a state in which the object is to be described; if the target object to be displayed is an object to be displayed with the display priority satisfying the preset display condition, the non-target object to be displayed is an object to be displayed with the display priority not satisfying the preset display condition; if the target object to be displayed is an object to be displayed with the heat value satisfying the preset heat condition, the non-target object to be displayed is an object to be displayed with the heat value not satisfying the preset heat condition.

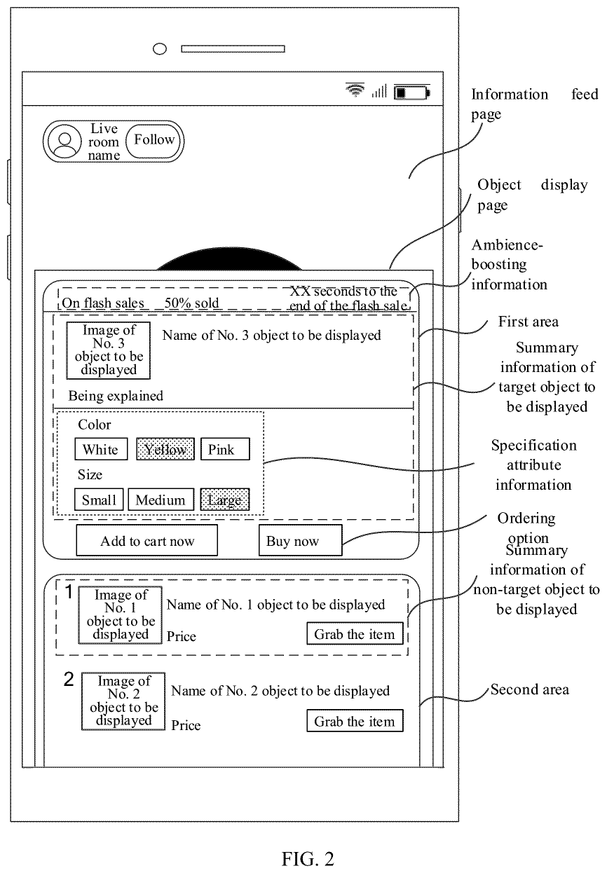

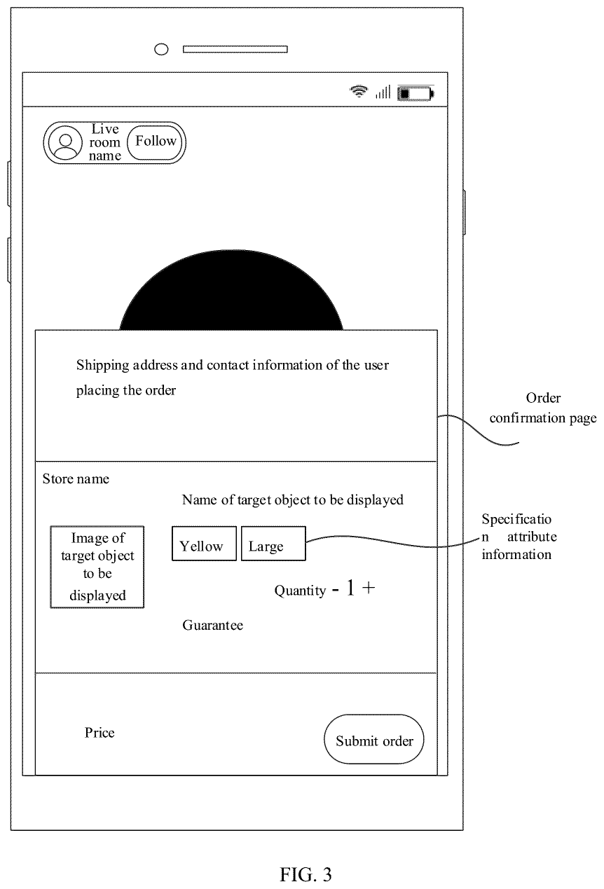

With reference to FIG. 2, the information feed page is a live streaming room display page. The live streaming room display page corresponds to a plurality of objects to be displayed including No. 1 to No. 3, which are all items. No. 1 object to be displayed is a target object to be displayed, and No. 2 and No. 3 are non-target objects to be displayed. The live streaming room display page comprises an object display page that is an item list. The object display page displays summary information of No. 3 object to be displayed and an ordering option. The summary information of No. 3 object to be displayed comprises specification attribute information of No. 3 object to be displayed. The object display page further displays summary information of No. 1 and No. 2 objects to be displayed, which does not comprise specification attribute information. Moreover, the object display page does not display an ordering option corresponding to No. 1 and No. 2 objects to be displayed.

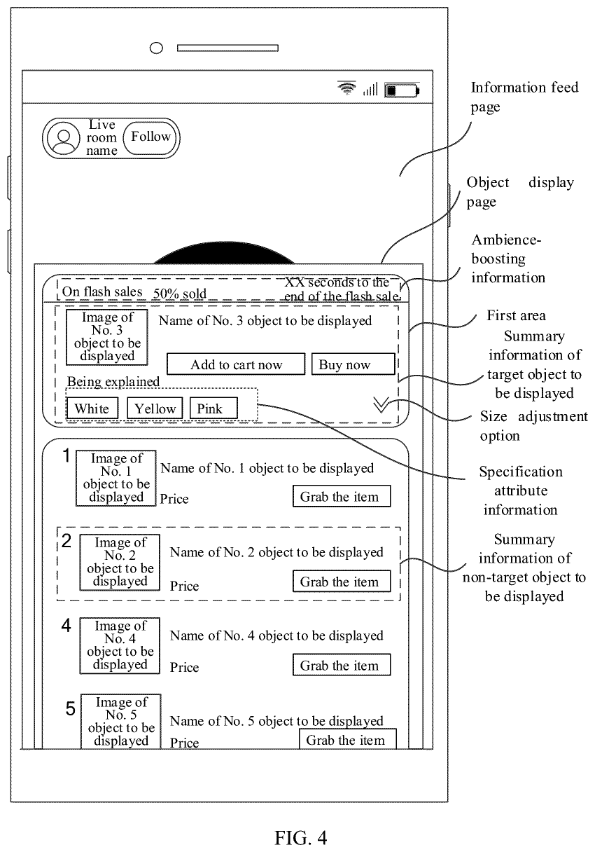

Still with reference to FIG. 2, in the summary information of No. 2 object to be displayed, the specification attribute information “yellow” and the specification attribute information “large” are in the selected state, which means that No. 3 object to be displayed is the selected object to be displayed. The user clicks on the ordering option (i.e., “Buy Now” control) of No. 3 object to be displayed in FIG. 2, and then an order confirmation page corresponding to No. 3 object to be displayed is displayed with reference to FIG. 4. In the order confirmation page, only the two specification attribute information in the selected state are displayed, i.e., “yellow” and “large”.

In one embodiment, prior to S120, at least one specification attribute information of the target object to be displayed is in the selected state by default. As an example, it may be set that the specification attribute information listed in the first place in any category of specification attribute information is in the selected state by default. As an example, if the target object to be displayed has three specification attribute information, i.e., small, large and medium. The three specification attribute information are all specification attribute information in the size category, and is listed from left to right in order of small, large and medium size. Where the user does not select the specification attribute information of the target object to be displayed, small size is the specification attribute in the selected state by default.

In another embodiment, prior to S120, the method further comprises: in response to a selection operation of at least one specification attribute information, switching the selected specification attribute information from an unselected state to a selected state.

The selection operation of at least one specification attribute information is an operation through which the user communicates to the terminal the recognized and favored specification attribute information. Specifically, the selection operation of at least one specification attribute information may be a click operation or swiping operation of one or more specific specification attribute information.

It is to be noted that in practice, if the target object to be displayed only comprises specification attribute information of one category, then in this step, only one specification attribute information is in the selected state. If the target object to be displayed comprises specification attribute information of N categories, then in this step, the N specification attribute information is all in the selected state, and each specification attribute information in the selected state corresponds to a different category. N is a positive integer greater than or equal to 2. The category of specification attribute information comprises size, style, material, color, etc.

Optionally, the display effect of the specification attribute information in the selected state is different from that of the specification specification information in the unselected state. Such a setting serves a purpose to make it easier for the user to intuitively distinguish which specification attribute information is in the selected state and which specification attribute information is in the unselected state.

To make the display effect of the specification attribute information in the selected state different from that of the specification attribute information in the unselected state, one of approaches may be adopted in reality: a background color of the specification attribute information in the selected state is different from a background color of the specification attribute information in the unselected state; a text color of the specification attribute information in the selected state is different from a text color of the specification attribute information in the unselected state; a border color of the specification attribute information in the selected state is different from a border color of the specification attribute information in the unselected state.

In the above technical solution, an information feed page is displayed, the information feed page comprising an object display page; the information feed page corresponds to several objects to be displayed; the object display page is used for displaying summary information of at least one of the objects to be displayed and an ordering option; the summary information of the at least one object to be displayed comprises specification attribute information of the object to be displayed; and in the event that the at least one specification attribute information of the object to be displayed is in a selected state, in response to a triggering operation of the order option corresponding to a selected object to be displayed, an order confirmation page corresponding to the selected object to be displayed is displayed, the selected object to be displayed being an object to be displayed with the at least one specification attribute information in the selected state. In general, the specification attribute information of the object to be displayed is transparently transmitted to the object display page. In this way, the user can directly select the specification attribute information of the object to be displayed on the object display page, which can simplify the steps of placing an order to buy the object to be displayed, shorten the time consumption of the operations of placing an order and achieve the purpose of one-click ordering.

On the basis of the above technical solution, optionally, in the event that one portion of the several objects to be displayed are target objects to be displayed and the other portion are non-target objects to be displayed, the object display page comprises a first area and a second area, the first area is used for displaying an order option and summary information of the target object to be displayed, and the second area is used for displaying summary information of the non-target object to be displayed; the first area is located above the second area.

Both the first area and the second area are areas in the object display page. The second area does not overlap with the first area. The specific locations of the first area and the second area in the object display page are specified in advance. The first area being located above the second area means that the first area is located on one side of the second area, and the distance from the center point of the first area to the upper boundary of the object display page is smaller than the distance from the center point of the second area to the upper boundary of the object display page.

Still referring to FIG. 2, No. 3 is the target object to be displayed, and No. 1 and No. 2 are non-target objects to be displayed. The summary information of No. 3 object to be displayed and an ordering option are displayed in the first area, and the summary information of No. 1 and No. 2 objects to be displayed is displayed in the second area.

Further, optionally, it may be set that a background color of the first area is different from a background color of the second area; or a text color of summary information of the target object to be displayed in the first area is different from a text color of summary information of the non-target object to be displayed in the second area; or a boundary line color of the first area is different from a boundary line color of the second area. Such a setting serves a purpose to make the display effect of the first area different from that of the second area, with the first area being highlighted to enable the user to quickly find the target object to be displayed.

On the basis of the above respective technical solutions, optionally, in the event that the first area comprises part of specification attribute information of the target object to be displayed, the first area further comprises a size adjustment option; and the method further comprises: in response to a selection operation on the size adjustment option, increasing size of the first area to cause the first area to comprise all of specification attribute information of the target object to be displayed.

“The first area comprising part of specification attribute information of the target object to be displayed” means that in the first area, not all specification attribute information of the target object to be displayed is displayed, but only part of specification attribute information of the target object to be displayed is displayed.

The size adjustment option refers to a control or area for increasing the area and size of the first area.

The selection operation of the size adjustment option may be, for example, a click operation or a swiping operation on the size adjustment option. The selection operation indicates that the user wants to increase the area and size of the first area.

It is to be noted that if the size of the first area before performing this step is the first size and the size of the first area after performing this step are the second size, since the second size is greater than the first size, the area of the first area after performing this step is larger than the area before performing this step. This means that after performing this step, the first area can display more information. Therefore, after performing this step, the first area can display all of the specification attribute information of the target object to be displayed.

Suppose the specification attribute information of the target object to be displayed comprises the specification attribute of size type and the specification attribute of color type. With reference to FIG. 4, the summary information of the target object to be displayed only comprises the specification attribute information of color type of the target object to be displayed and does not comprise the specification attribute information of size type, i.e., the first area comprises part of the specification attribute information of the target object to be displayed. Still with reference to FIG. 4, the first area further comprises the size adjustment option. After detecting that the user selects the size adjustment option, with reference to FIG. 2, the size of the first area is increased, at which point all of the specification attribute information of the target object to be displayed is displayed in the first area (i.e., comprising specification attributes of both size type and color type).

On the basis of the above technical solution, optionally, summary information of the target object to be displayed further comprises ambience-boosting information; and the ambience-boosting information comprises heat information of the object to be displayed and/or promotion campaign information associated with the target object to be displayed.

The ambience-boosting information is information for attracting the user's attention and creating a cheerful, enthusiastic ambience.

The heat information of the object to be displayed may be, for example, information for describing the popularity degree of the object to be displayed. As an example, the heat information of the object to be displayed comprises heat state information and/or a heat value. The heat value refers to information that describes the popularity degree of the object to be displayed in numerical form. As an example, the heat value of the object to be displayed may comprise at least one of: the number of followers, favorites, purchases, reviews, positive reviews, shares, views, inquiries, and likes of the object to be displayed. The heat state information refers to information that describes the popularity degree of the object to be displayed in text form. As an example, the heat state information may comprise at least one of: best seller, positive review, etc.

The promotion campaign refers to a campaign carried out to increase the popularity or attention of an object among users. Under e-commerce scenarios, the promotion campaign may specifically comprise a marketing campaign, such as low price promotions, full reduction campaigns, group buying campaigns, and so on. As an example, the promotion campaign information is information that describes the specific content of the promotion campaign.

The promotion campaign information associated with the target object to be displayed may be, for example, information describing the specific content of a promotion campaign in which the target object to be displayed participates.

The present application is not intended to limit the display location of the ambience-boosting information. Optionally, the display location of the ambience-boosting information is located above the display location of the summary information. With reference to FIG. 2 or 4, in the first area, the display location of the ambience-boosting information is closer to the top boundary line of the first area than the display location of the summary information. The ambience-boosting information indicates that the current target object to be displayed currently participates in flash sale.

On the basis of the above technical solution, optionally, the object display page further comprises an add-to-cart option corresponding to the target object to be displayed; and the method comprises: in the event that the at least one specification attribute information of the target object to be displayed is in a selected state, in response to a triggering operation of the add-to-cart option corresponding to the target object to be displayed, adding a minimum stock unit defined by the specification attribute information in the selected state to a collection of objects to be ordered.

The collection of objects to be ordered may be, for example, a cart.

The add-to-cart option is an option specially designed for the target object to be and used to quickly add the target object to be displayed to the collection of objects to be ordered. After the add-to-cart option is triggered, the cart page will be directly displayed, while the specification attribute selection page will not be displayed, nor will the item details page be displayed.

The triggering operation of the add-to-cart option may be, for example, a click operation or swiping option of the add-to-cart option. Since the user can directly select the specification attribute information of the object to be displayed on the object display page, which can simplify the steps of adding the object to be displayed to the cart and shorten the time consumption of the operations of adding to cart.

Further, the summary information comprises image information; if at least one specification attribute information is in the selected state, the image information is image information of the target object to be displayed under the specification attribute in the selected state. The image information is a picture or dynamic image of the object to be displayed corresponding to the summary information. As an example, still with reference to FIG. 2, suppose the target object to be displayed is a T-shirt. If the “yellow” specification attribute information of the target object to be displayed is in the selected state at a certain point, the image information is a picture of the yellow T-shirt. If the “white” specification attribute information of the target object to be displayed is in the selected state at another point, the image information is a picture of the white T-shirt.

Further, the summary information of the target object to be displayed comprises label information; if at least one specification attribute information is in the selected state, the label information is label information of the target object to be displayed under the specification attribute in the selected state. The label information is used formed by one or more of information in the summary information other than the specification attribute information and image information. As an example, suppose the label information comprises selling point information and a price. The selling point information may be a feature of an attribute of the object to be displayed and may be the strongest reason for consumption. Suppose the “white” specification attribute information of the T shirt (i.e., target object to be displayed) is in the selected state at a certain point, then the label information is the selling point information and price of the white T-shirt. If the “yellow” specification attribute information of the T shirt (i.e., target object to be displayed) is in the selected state at a certain point, then the label information is the selling point information and price of the yellow T-shirt.

It is to be noted that for each of the foregoing method embodiments, they are all described as combinations of a series of actions for the sake of simplicity of description. However, it should be appreciated by those skilled in the art that the present invention is not limited by the order of actions described, because certain steps may be carried out in other order or simultaneously based on the present invention. In addition, those skilled in the art should further be aware that the embodiments described in the specification are preferred embodiments and that the actions and modules involved herein are not necessarily indispensable to the present invention.

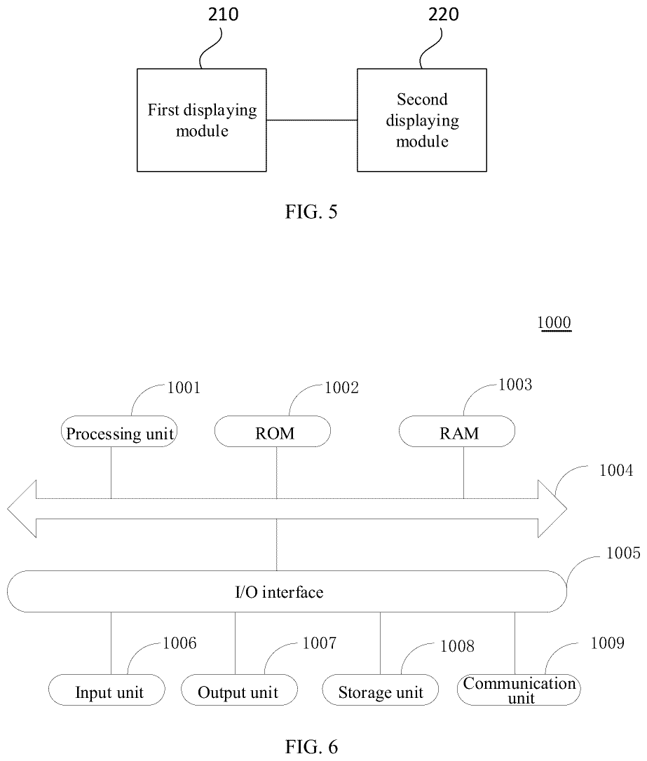

FIG. 5 shows a structural schematic diagram of an information displaying apparatus in an embodiment of the present disclosure. The information displaying apparatus provided in this embodiment of the present disclosure may be configured in a client. With reference to FIG. 5, the information displaying apparatus specifically comprises:
a first displaying module 210 configured to display an information feed page, the information feed page comprising an object display page; the information feed page corresponding to several objects to be displayed; the object display page being used for displaying summary information of at least one of the objects to be displayed and an ordering option; the summary information of the at least one object to be displayed comprising specification attribute information of the object to be displayed; and
a second displaying module 220 configured to, in the event that the at least one specification attribute information of the object to be displayed is in a selected state, in response to a triggering operation of the ordering option corresponding to a selected object to be displayed, display an order confirmation page corresponding to the selected object to be displayed, the selected object to be displayed being an object to be displayed with the at least one specification attribute information in the selected state.

Further, all of the several objects to be displayed are target objects to be displayed; or, all of the several objects to be displayed are non-target objects to be displayed; or, one portion of the several objects to be displayed are target objects to be displayed and the other portion of the several objects to be displayed are non-target object to be displayed;
the target object to be displayed comprises at least one of: an object to be displayed in an explained state, an object to be displayed with a display priority satisfying a preset display condition, and an object to be displayed with a heat value satisfying a preset heat condition;
in the event that the several objects to be displayed comprise a target object to be displayed, the object display page comprises an ordering option and summary information of the target object to be displayed, and the summary information of the target object to be displayed comprises specification attribute information; and
in the event that the several objects to be displayed comprise a non-target object to be displayed, the object display page comprises summary information of the non-target object to be displayed, and summary information of the target object to be displayed does not comprise specification attribute information.

Further, in the event that one portion of the several objects to be displayed are target objects to be displayed and the other portion are non-target objects to be displayed, the object display page comprises a first area and a second area, the first area is used for displaying an ordering option and summary information of the target object to be displayed, and the second area is used for displaying summary information of the non-target object to be displayed;
the first area is located above the second area.

Further, a background color of the first area is different from a background color of the second area; or
a text color of summary information of the target object to be displayed in the first area is different from a text color of summary information of the non-target object to be displayed in the second area; or
a boundary line color of the first area is different from a boundary line color of the second area.

Further, in the event that the first area comprises part of specification attribute information of the target object to be displayed, the first area further comprises a size adjustment option; and the apparatus further comprises a third displaying module configured to:
in response to a selection operation on the size adjustment option, increase size of the first area to cause the first area to comprise all of specification attribute information of the target object to be displayed.

Further, summary information of the target object to be displayed further comprises ambience-boosting information; and
the ambience-boosting information comprises heat information of the object to be displayed and/or promotion campaign information associated with the target object to be displayed.

Further, the object display page further comprises an add-to-cart option corresponding to the target object to be displayed; and the apparatus comprises a fourth displaying module configured to:
in the event that the at least one specification attribute information of the target object to be displayed is in a selected state, in response to a triggering operation of the add-to-cart option corresponding to the target object to be displayed, add a minimum stock unit defined by the specification attribute information in the selected state to a collection of objects to be ordered.

Further, the information feed page comprises a live streaming room preview feed page or a live streaming room display page;
the object to be displayed comprises an item;
the specification attribute information comprises at least one of: size, style, material, and color.

The information displaying apparatus provided by the embodiment of the present disclosure can perform the steps performed by the client in the information displaying method provided by the method embodiments of the present disclosure, with execution steps and advantageous effects which are not repeated here.

FIG. 6 is a structural schematic diagram of an electronic device in the embodiments of the present disclosure. With reference to FIG. 6 below, this figure shows a structural schematic diagram of an electronic device 1000 which is applicable to implement the embodiments of the present disclosure. The electronic device 1000 in the embodiments of the present disclosure may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal), a wearable terminal device and the like, and a fixed terminal such as digital TV, a desktop computer, a smart home device and the like. The electronic device shown in FIG. 6 is merely an example and should not be construed as bringing any restriction on the functionality and usage scope of the embodiments of the present disclosure.

As shown in FIG. 6, the electronic device 1000 may comprise a processing unit (e.g., a central processor, a graphics processor) 1001 which is capable of performing various appropriate actions and processes to realize the information displaying method as described in the embodiments of the present disclosure in accordance with programs stored in a read only memory (ROM) 1002 or programs loaded from a storage unit 1008 to a random access memory (RAM) 1003. In the RAM 1003, there are also stored various programs and data required by the electronic device 1000 when operating. The processing unit 1001, the ROM 1002 and the RAM 1003 are connected to one another via a bus 1004. An input/output (I/O) interface 1005 is also connected to the bus 1004.

Usually, the following units may be connected to the I/O interface 1005: an input unit 1006 including a touch screen, a touch pad, a keyboard, a mouse, a camera, a microphone, an accelerometers, a gyroscope, or the like; an output unit 1007, such as a liquid-crystal display (LCD), a loudspeaker, a vibrator, or the like; a storage unit 1008, such as a magnetic tape, a hard disk or the like; and a communication unit 1009. The communication unit 1009 allows the electronic device 1000 to perform wireless or wired communication with other device so as to exchange data with other device. While FIG. 6 shows the electronic device 1000 with various units, it is to be understood that it is not required to implement or have all of the illustrated units. Alternatively, more or less units may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication unit 1009, or installed from the storage unit 1008, or installed from the ROM 1002. The computer program, when executed by the processing unit 1001, perform the above functions defined in the method of the embodiments of the present disclosure.

It is to be noted that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

In some implementations, the client and the server may communicate using any network protocol that is currently known or will be developed in future, such as the hyper text transfer protocol (HTTP) and the like, and may be interconnected with digital data communication (e.g., communication network) in any form or medium. Examples of communication networks include local area networks (LANs), wide area networks (WANs), inter-networks (e.g., the Internet) and end-to-end networks (e.g., ad hoc end-to-end networks), as well as any networks that are currently known or will be developed in future.

The above computer readable medium may be included in the above-mentioned electronic device; and it may also exist alone without being assembled into the electronic device.

The computer readable medium carries one or more programs. The one or more programs, when executed by the electronic device, cause the electronic device to: display an information feed page, the information feed page comprising an object display page; the information feed page corresponding to several objects to be displayed; the object display page being used for displaying summary information of at least one of the objects to be displayed and an ordering option; the summary information of the at least one object to be displayed comprising specification attribute information of the object to be displayed; and
in the event that the at least one specification attribute information of the object to be displayed is in a selected state, in response to a triggering operation of the ordering option corresponding to a selected object to be displayed, display an order confirmation page corresponding to the selected object to be displayed, the selected object to be displayed being an object to be displayed with the at least one specification attribute information in the selected state.

Optionally, when the one or more programs are executed by the electronic device, the electronic device may further perform other steps described in the above embodiments.

Computer program codes for carrying out operations of the present disclosure may be written in one or more programming languages, including without limitation to, an object-oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware, wherein the name of a unit does not form any limitation to the unit per se in some case.

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine-readable medium may be a tangible medium, which may include or store a program used by an instruction executing system, apparatus or device or used in conjunction with the foregoing. The machine-readable medium may be a machine readable signal medium or a machine readable storage medium. The machine-readable medium may include, but is not limited to, an electronic, magnetic, optical, electromagnetic, infrared, semiconductor system, means or device, or any suitable combination of the foregoing. More specific examples of the machine-readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

According to one or more embodiments of the present disclosure, an electronic device is provided, comprising:
one or more processors;
a storage unit configured to store one or more programs,
the one or more programs, when executed by the one or more processors, causing the one or more processors to implement the information displaying method as described in the present disclosure.

According to one or more embodiments of the present disclosure, a computer readable storage medium is provided, storing a computer program thereon, wherein the computer program, when executed by a processor, implements the information displaying method as described in the present disclosure.

The embodiments of the present disclosure further provide a computer program product, comprising a computer program or instructions which, when executed by a processor, implement the information displaying method as described in the present disclosure.

It is to be noted that relational terms used herein such as “first” and “second” are only used for distinguishing one entity or operation from another, and do not necessarily require or imply the existence of any such actual relationship or order between these entities or operations. Moreover, the terms “comprise”, “include” or any other variant thereof are intended to cover non-exclusive inclusion, so that a process, method, article or device comprising a set of elements includes not only those elements, but also other elements that are not expressly listed or are inherent to such process, method, article or equipment. Without further limitation, an element defined by the phrase “comprising a . . . ” does not exclude the existence of another identical element in the process, method, article or device including the element.

The specific implementations of the present disclosure have been described above, enabling those skilled in the art to understand or implement the present disclosure. Various modifications to these embodiments are apparent to those skilled in the art, and general principles defined herein may be realized in other embodiments without departing from the spirit or scope of the present disclosure. Therefore, the present disclosure will not be limited to these embodiments illustrated herein but accord with the broadest scope consistent with the principles and novel features disclosed herein.

I/We claim:

1. An information displaying method comprising:
displaying an information feed page, the information feed page comprising an object display page; the information feed page corresponding to several objects to be displayed; the object display page being used for displaying summary information of at least one of the objects to be displayed and an order option; and the summary information of the at least one object to be displayed comprising specification attribute information of the object to be displayed; and
in the event that the at least one specification attribute information of the object to be displayed is in a selected state, in response to a triggering operation of the order option corresponding to a selected object to be displayed, displaying an order confirmation page corresponding to the selected object to be displayed, the selected object to be displayed being an object to be displayed with the at least one specification attribute information in the selected state.

2. The method of claim 1, wherein all of the several objects to be displayed are target objects to be displayed; or, all of the several objects to be displayed are non-target objects to be displayed; or, one portion of the several objects to be displayed are target objects to be displayed and the other portion of the several objects to be displayed are non-target object to be displayed;
the target object to be displayed comprises at least one of the following: an object to be displayed in an explained state, an object to be displayed with a display priority satisfying a preset display condition, or an object to be displayed with a heat value satisfying a preset heat condition;
in the event that the several objects to be displayed comprise a target object to be displayed, the object display page comprises an order option and summary information of the target object to be displayed, and the summary information of the target object to be displayed comprises specification attribute information; and
in the event that the several objects to be displayed comprise a non-target object to be displayed, the object display page comprises summary information of the non-target object to be displayed, and summary information of the target object to be displayed does not comprise specification attribute information.

3. The method of claim 2, wherein in the event that the one portion of the several objects to be displayed are target objects to be displayed and the other portion are non-target objects to be displayed, the object display page comprises a first area and a second area, the first area is used for displaying an order option and summary information of the target object to be displayed, and the second area is used for displaying summary information of the non-target object to be displayed; and
the first area is located above the second area.

4. The method of claim 3, wherein:
a background color of the first area is different from a background color of the second area; or
a text color of summary information of the target object to be displayed in the first area is different from a text color of summary information of the non-target object to be displayed in the second area; or
a boundary line color of the first area is different from a boundary line color of the second area.

5. The method of claim 3, wherein in the event that the first area comprises part of specification attribute information of the target object to be displayed, the first area further comprises a size adjustment option; and the method further comprises:
in response to a selection operation on the size adjustment option, increasing size of the first area to cause the first area to comprise all of specification attribute information of the target object to be displayed.

6. The method of claim 1, wherein summary information of the target object to be displayed further comprises ambience-boosting information; and
the ambience-boosting information comprises heat information of the object to be displayed and/or promotion activity information associated with the target object to be displayed.

7. The method of claim 2, wherein the object display page further comprises an add-to-cart option corresponding to the target object to be displayed; and the method further comprises:
in the event that the at least one specification attribute information of the target object to be displayed is in a selected state, in response to a triggering operation of the add-to-cart option corresponding to the target object to be displayed, adding a minimum stock unit defined by the specification attribute information in the selected state to a set of objects to be ordered.

8. The method of claim 1, wherein the information feed page comprises a live streaming channel preview feed page or a live streaming channel display page;
the object to be displayed comprises goods;
the specification attribute information comprises at least one of: size, style, material, or color.

9. An electronic device, comprising:
one or more processors;
a storage unit for storing one or more programs;
wherein the one or more programs, when executed by the one or more processors, cause the one or more processors to:
display an information feed page, the information feed page comprising an object display page; the information feed page corresponding to several objects to be displayed; the object display page being used for displaying summary information of at least one of the objects to be displayed and an order option; and the summary information of the at least one object to be displayed comprising specification attribute information of the object to be displayed; and
in the event that the at least one specification attribute information of the object to be displayed is in a selected state, in response to a triggering operation of the order option corresponding to a selected object to be displayed, display an order confirmation page corresponding to the selected object to be displayed, the selected object to be displayed being an object to be displayed with the at least one specification attribute information in the selected state.

10. The electronic device of claim 9, wherein all of the several objects to be displayed are target objects to be displayed; or, all of the several objects to be displayed are non-target objects to be displayed; or, one portion of the several objects to be displayed are target objects to be displayed and the other portion of the several objects to be displayed are non-target object to be displayed;
the target object to be displayed comprises at least one of the following: an object to be displayed in an explained state, an object to be displayed with a display priority satisfying a preset display condition, or an object to be displayed with a heat value satisfying a preset heat condition;
in the event that the several objects to be displayed comprise a target object to be displayed, the object display page comprises an order option and summary information of the target object to be displayed, and the summary information of the target object to be displayed comprises specification attribute information; and
in the event that the several objects to be displayed comprise a non-target object to be displayed, the object display page comprises summary information of the non-target object to be displayed, and summary information of the target object to be displayed does not comprise specification attribute information.

11. The electronic device of claim 10, wherein in the event that the one portion of the several objects to be displayed are target objects to be displayed and the other portion are non-target objects to be displayed, the object display page comprises a first area and a second area, the first area is used for displaying an order option and summary information of the target object to be displayed, and the second area is used for displaying summary information of the non-target object to be displayed; and
the first area is located above the second area.

12. The electronic device of claim 11, wherein:
a background color of the first area is different from a background color of the second area; or
a text color of summary information of the target object to be displayed in the first area is different from a text color of summary information of the non-target object to be displayed in the second area; or
a boundary line color of the first area is different from a boundary line color of the second area.

13. The electronic device of claim 11, wherein in the event that the first area comprises part of specification attribute information of the target object to be displayed, the first area further comprises a size adjustment option; and the one or more processors are further caused to:
in response to a selection operation on the size adjustment option, increase size of the first area to cause the first area to comprise all of specification attribute information of the target object to be displayed.

14. The electronic device of claim 9, wherein summary information of the target object to be displayed further comprises ambience-boosting information; and
the ambience-boosting information comprises heat information of the object to be displayed and/or promotion activity information associated with the target object to be displayed.

15. The electronic device of claim 10, wherein the object display page further comprises an add-to-cart option corresponding to the target object to be displayed; and the one or more processors are further caused to:
in the event that the at least one specification attribute information of the target object to be displayed is in a selected state, in response to a triggering operation of the add-to-cart option corresponding to the target object to be displayed, add a minimum stock unit defined by the specification attribute information in the selected state to a set of objects to be ordered.

16. The electronic device of claim 9, wherein the information feed page comprises a live streaming channel preview feed page or a live streaming channel display page;
the object to be displayed comprises goods;
the specification attribute information comprises at least one of: size, style, material, or color.

17. A non-transitory computer readable storage medium storing a computer program thereon, wherein the computer program, when executed by a processor, implements a method comprising:
displaying an information feed page, the information feed page comprising an object display page; the information feed page corresponding to several objects to be displayed; the object display page being used for displaying summary information of at least one of the objects to be displayed and an order option; and the summary information of the at least one object to be displayed comprising specification attribute information of the object to be displayed; and
in the event that the at least one specification attribute information of the object to be displayed is in a selected state, in response to a triggering operation of the order option corresponding to a selected object to be displayed, displaying an order confirmation page corresponding to the selected object to be displayed, the selected object to be displayed being an object to be displayed with the at least one specification attribute information in the selected state.

18. The non-transitory computer readable storage medium of claim 17, wherein all of the several objects to be displayed are target objects to be displayed; or, all of the several objects to be displayed are non-target objects to be displayed; or, one portion of the several objects to be displayed are target objects to be displayed and the other portion of the several objects to be displayed are non-target object to be displayed;
the target object to be displayed comprises at least one of the following: an object to be displayed in an explained state, an object to be displayed with a display priority satisfying a preset display condition, or an object to be displayed with a heat value satisfying a preset heat condition;
in the event that the several objects to be displayed comprise a target object to be displayed, the object display page comprises an order option and summary information of the target object to be displayed, and the summary information of the target object to be displayed comprises specification attribute information; and
in the event that the several objects to be displayed comprise a non-target object to be displayed, the object display page comprises summary information of the non-target object to be displayed, and summary information of the target object to be displayed does not comprise specification attribute information.

19. The non-transitory computer readable storage medium of claim 18, wherein in the event that the one portion of the several objects to be displayed are target objects to be displayed and the other portion are non-target objects to be displayed, the object display page comprises a first area and a second area, the first area is used for displaying an order option and summary information of the target object to be displayed, and the second area is used for displaying summary information of the non-target object to be displayed; and
the first area is located above the second area.

20. The non-transitory computer readable storage medium of claim 19, wherein:
a background color of the first area is different from a background color of the second area; or
a text color of summary information of the target object to be displayed in the first area is different from a text color of summary information of the non-target object to be displayed in the second area; or
a boundary line color of the first area is different from a boundary line color of the second area.
